(19) United States
(12) Patent Application Publication
(10) Pub. No.: US 2008/0110068 A1
(43) Pub. Date: May 15, 2008

(54) Tanning bed sanitized sign

(76) Inventors: Caroline Pugmire, Omaha, NE (US); Robert L. Pugmire, Omaha, NE (US)

Correspondence Address: THOMTE LAW OFFICE, L.L.C., 2120 S. 72ND STREET, SUITE 1111, OMAHA, NE, 68124, US

(21) Appl. No.: 11/983,081

(22) Filed: Nov. 7, 2007

Related U.S. Application Data
(60) Provisional application No. 60/858,131, filed on Nov. 9, 2006.

(51) Int. Cl. G09F 7/00

(52) U.S. Cl. 40/584

(57) ABSTRACT

A tanning bed sanitized sign which is comprised of a compression molded EVA foam or the like which is formed by cutting the foam into sheets. The sign may be shipped flat and then folded into a tent and placed on the tanning bed when the tanning bed has been sanitized.

### CROSS-REFERENCE TO RELATED APPLICATION

This application claims the benefit of U.S. Provisional Application Ser. No. 60/858,131 entitled “TANNING BED SANITIZED SIGN” filed Nov. 9, 2006, the disclosure of which is hereby incorporated herein by reference.

### BACKGROUND OF THE INVENTION

1. Field of the Invention

This invention relates to a sign for placement on a tanning bed to advise the tanner that the bed has been sanitized and is ready for use. More particularly, the sign is in the form of a tent which is formed from compression molded EVA foam.

2. Description of the Related Art

In commercial tanning salons, a sanitizing sign or tent is normally placed on the tanning bed which advises the next customer or tanner that the bed has been sanitized and is ready for use. Historically, a majority of the sanitized signs have been constructed of an acrylic material. Although the acrylic sanitized signs do perform their function, they frequently break when they are accidentally dropped or knocked off the tanning bed. If the acrylic sign breaks or shatters, the shards or pieces of the sign may cause injury to persons coming into contact therewith such as by stepping thereon. Further, the acrylic signs, when placed upon the acrylic tanning bed, may scratch or damage the bed. Some sanitized signs have also been provided which are in the form of folded paper tents, but the sanitized signs of paper construction are not durable.

### SUMMARY OF THE INVENTION

A tanning bed sanitized sign comprised of a compression molded EVA foam. The EVA foam material is a closed cell foam material and is very UV stable and may be produced to include good coloring. The sanitized sign of this invention is formed by cutting the EVA foam into sheets. The sheets are heated in an oven and then placed in a cold metal tool that has the desired design cut into it. The foam is molded into the sign and cooled. The final part is then die cut. The sign may be shipped flat and then folded into a tent and placed on the tanning bed when the tanning bed has been sanitized. The closed cell foam construction of the sign makes it extremely durable and will not break should the same be dropped or accidentally knocked from the tanning bed.

It is therefore a principal object of the invention to provide an improved tanning bed sanitized sign.

A further object of the invention is to provide a tanning bed sanitized sign which is constructed of a closed cell foam material.

A further object of the invention is to provide a tanning bed sanitized sign which is constructed of an EVA closed cell foam material.

Still another object of the invention is to provide a tanning bed sanitized sign which may be shipped flat and then assembled at the desired location into a tent for placement on the tanning bed.

Yet another object of the invention is to provide an improved tanning bed sanitized sign which is extremely durable and attractive in use.

Yet another object of the invention is to provide an improved tanning bed sanitized sign that will not damage the acrylic tanning bed.

Yet another object of the invention is to provide an improved tanning bed sanitized sign that will not break, thereby preventing possible injury to persons using the tanning bed.

These and other objects will be apparent to those skilled in the art.

### BRIEF DESCRIPTION OF THE DRAWINGS

FIG. 1 is a front perspective view of the sign of this invention in its assembled condition;

FIG. 2 is a side view of the sign of FIG. 1;

FIG. 3 is a plan view of the sign in its flat condition;

FIG. 4 is a side view of the sign of FIG. 3; and

FIG. 5 is a bottom perspective view of the sign in its folded position.

### DETAILED DESCRIPTION OF THE INVENTION

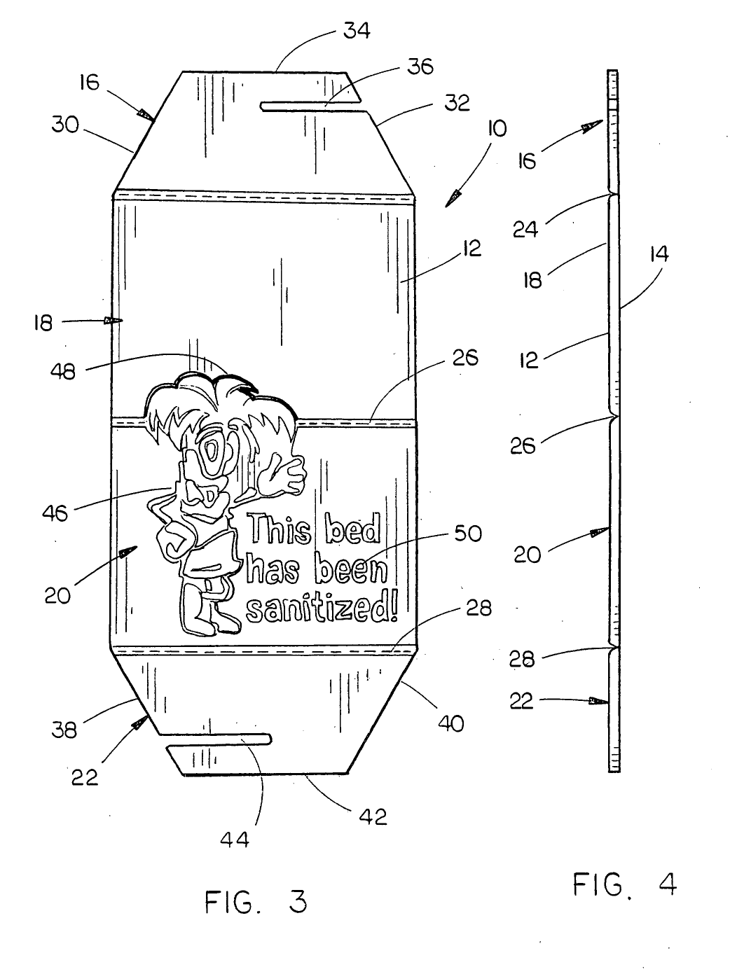

The numeral 10 refers to the tanning bed sanitized sign or tent of this invention. FIG. 3 illustrates the sign 10 of this invention in its flat or unfolded condition while FIGS. 1, 2 and 5 illustrate the sign in its assembled or folded condition. The sign 10 is comprised of compression molded EVA foam. EVA is a closed cell foam and is very UV stable and is excellently color receptive. The EVA foam is cut into a sheet, as illustrated in FIG. 3.

For purposes of description, the sign 10 will be described as having opposite sides 12 and 14. Sign 10 includes panel portions 16, 18, 20 and 22, as seen in FIG. 3. Panel portions 16 and 18 have a longitudinally extending indentation, fold line or line hinge 24 formed therebetween while panel portions 18 and 20 have an elongated indentation, fold line or line hinge 26 formed therebetween. Panel portions 20 and 22 have an elongated indentation, fold line or line hinge 28 therebetween. The fold lines or line hinges 24, 26 and 28 enable the sheet to be folded from its flat position of FIGS. 3 and 4 to the folded positions of FIGS. 1, 2 and 5.

As seen in FIG. 3, panel 16 is trapezoidal in shape and is defined by side edges 30 and 32 and end edge 34. An elongated slot 36 extends inwardly into panel 16 from side edge 32, as seen in FIG. 3.

Panel 22 is also trapezoidal in shape and includes side edges 38 and 40 and end edge 42. An elongated slot 44 extends inwardly into panel 22 from side edge 38, as seen in FIG. 3.

The numeral 46 refers generally to a figure or design formed in panels 20 and 18. Panel 18 is provided with a cut line 48 at the upper end of the FIG. 46 so that the upper end of the FIG. 46 will project upwardly from the sign when the sign has been folded to its operative position, as seen in FIG. 1. Panel 26 also has the words “This bed has been sanitized!” formed therein which is referred to generally by the reference numeral 50.

The sign is created as will now be described. As stated previously, the EVA foam is cut into sheets. The sheet is heated in an oven and is then put in a cold metal tool that has the design cut into it as well as the necessary tooling to create the fold lines 24, 26 and 28 as well as the FIG. 46 and the wording 50. The foam is molded into the sign and then cooled. The final part is then die cut.

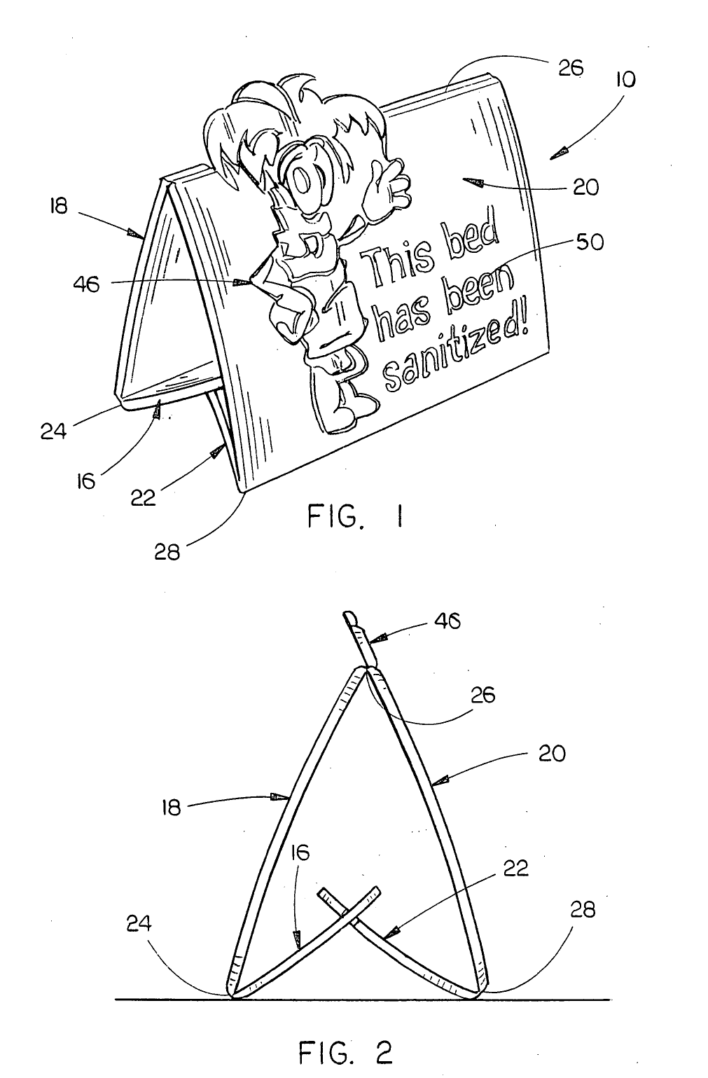

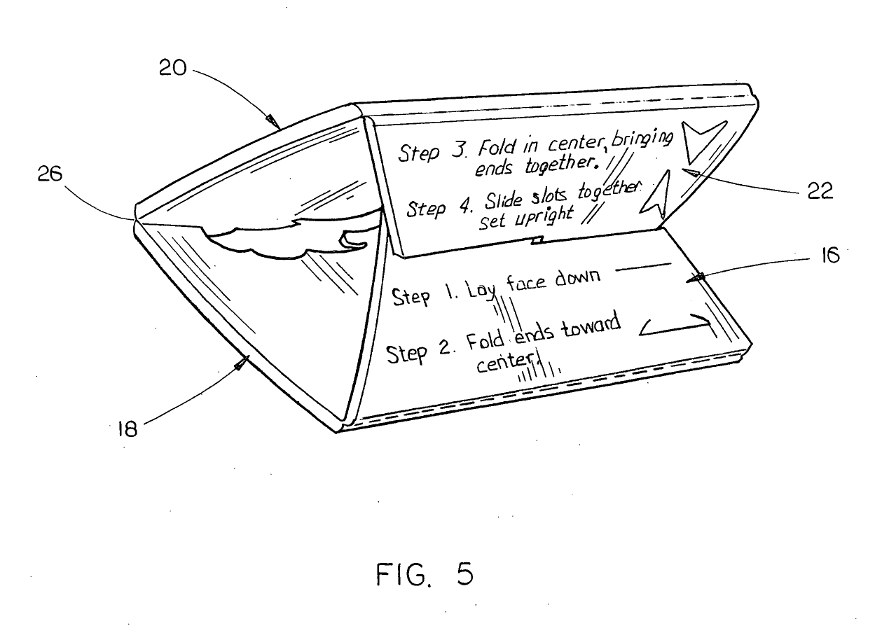

The panels 16 and 22 are also provided with assembly descriptions formed therein during the molding process, as best seen in FIG. 5. The flat sheets are shipped to the desired location and are then assembled as follows. The sign 10 is placed face down so that side 14 is uppermost. The end panels 16 and 22 are then folded towards the center, as illustrated by illustration in FIG. 5 at Step 2. The center of the sign is then folded inwardly along the fold line 26. The slots 36 and 44 are then slid together and the sign is then placed in an upright position. When placed in the upright position as seen in FIGS. 1 and 2, the panels 16 and 22 extend upwardly and inwardly towards one another. The assembled sign 10 is then placed on the tanning bed after the bed has been sanitized to advise the next tanner that the bed has been sanitized and is ready for use. The EVA foam construction of the sign 10 makes the sign extremely durable in that it will not break if dropped onto the floor or knocked from the tanning bed.

Thus it can be seen that a novel tanning bed sanitized sign has been provided which accomplishes at least all of its stated objectives.

I claim:

1. A sign for indicating that a tanning bed has been sanitized, comprising:
a selectively foldable panel means comprised of a foam material and having a front side and a back side;
said panel means being selectively foldable from a flat position to a tent-like position;
said panel means comprising:
(a) a first trapezoidal-shaped panel member having an upper end, first and second side edges, and a lower end;
(b) a second generally square or rectangular shaped panel member having an upper end, first and second side edges, and a lower end;
(c) a third generally square or rectangular shaped panel member hand an upper end, first and second side edges, and a lower end; and
(d) a fourth trapezoidal-shaped panel member having an upper end, first and second side edges, and a lower end;
said lower end of said first panel member and said upper end of said second panel member being joined by a first fold line;
said lower end of said second panel member and said upper end of said third panel member being joined by a second fold line;
said lower end of said third panel member and said upper end of said fourth panel member being joined by a third fold line;
said first panel member having a first elongated slot formed therein which extends inwardly thereto from its said second side edge;
said fourth panel member having a second elongated slot formed therein which extends inwardly thereto from its said first side edge;
at least one of said second and third panels having indicia thereon which indicates a sanitized condition;
said panel means being folded along said fold lines into said tent-like position and maintained in said tent-like position by connecting said first and fourth panel members together by means of said first and second slots.

2. The sign of claim 1 wherein said fold lines are formed by indentations extending inwardly into said front side of said panel means.

3. The sign of claim 1 wherein said foam material is a closed cell foam.

4. The sign of claim 1 wherein said foam material is comprised of compression molded EVA foam.

5. The sign of claim 1 wherein said indicia is formed by indentations extending into said front side of said panel means.

6. The sign of claim 5 wherein a design is also provided in said at least one of said second and third panel members.

7. The sign of claim 6 wherein said design is formed by indentations extending into said front side of said panel means.

8. The sign of claim 1 wherein said indicia is formed in said third panel member by indentations extending into said front side of said panel means and wherein a design is also formed in said third panel member and a portion of said second panel member, said portion of said design which is formed in said third panel member is created by indentations extending into said third panel member and wherein said portion of said design which is formed in said second panel member is formed by a cut line extending completely through said second panel member so that said portion of said design which is formed in said second panel member will extend upwardly from said upper end of said third panel ember when said sign is in its tent-like position.

9. The sign of claim 1 wherein said first and second trapezoidal-shaped panel members when jointed together by said slots extend upwardly and inwardly with respect to said second and third panel members respectively.
